(19) United States
(12) Patent Application Publication
(10) Pub. No.: US 2015/0245589 A1
(43) Pub. Date: Sep. 3, 2015

(54) Animal Litter Box with Open Roof and Sidewall Entrance

(71) Applicant: Heather Pace, San Mateo, CA (US)

(72) Inventor: Heather Pace, San Mateo, CA (US)

(21) Appl. No.: 14/193,696

(22) Filed: Feb. 28, 2014

(51) Int. Cl. A01K 1/01

(52) U.S. Cl. CPC A01K 1/0107

(57) ABSTRACT

A litter box with an open roof formed by inwardly arced gutters and a sidewall entrance is provided. The sidewall entrance also includes an inwardly arced gutter that extends from the bottom edge of the sidewall entrance into the interior space of the litter box. The inwardly arced gutters redirect litter kicked against the walls of the litter box back into the center of the box to prevent litter spilling and tracking. The open roof allows for better ventilation and animal comfort and prevents the litter box from being used as a safety hideout by animals. The sidewall entrance allows easy access to the litter box by animals.

### FIELD OF THE INVENTION

The present invention relates to an animal litter box for animals such as cats and dogs.

### BACKGROUND OF THE INVENTION

Litter box is an indoor animal feces and urine disposal box that allows pets such as cats and dogs to evacuate without having to go outside. A litter box's bottom is generally lined with an inch (2.5 cm) or more litter box filler or litter which is typically granular material that absorbs moisture and odors such as ammonia from the animal feces and urine. Some example litter box fillers are clay, recycled paper pellets and silica-based crystals.

Today there are many different litter box solutions that are commercially available, these litter boxes typically exist in either open or closed configurations. Open litter box are generally the most basic and least expensive design and are commonly in the shape of a rectangular tray with low sidewalls (e.g., 4 to 6 inches high). Open litter boxes have the advantage of allowing for maximum ventilation which increases pets comfort and are generally preferred by pets. However, the low rising walls of these open litter boxes may not be able to contain litter when a pet kicks or digs to bury excreted materials. In addition, some pets eliminate standing up could urinate/defecate over the low rise walls to cause soiling of the surrounding environment. Although some open litter boxes have high sidewalls and are less likely to have problems with litter spilling and tracking, they are typically not easy for pets to get in and out and consequently are not recommended for older or obese pets or pets otherwise with poor physical health.

A variety of closed or covered litter boxes are also available commercially. Since the sidewalls are enclosed, they have fewer problems with litter spilling and tracking. However, closed or covered litter boxes have several disadvantages. Pets, particularly cats, typically prefer an open environment for voiding, versus a closed, confined space. In addition, a closed environment may be used by pets as a safety hideout, this can become a nuisance for the pet owner as soiling of the pet's fur and body may occur when the pet spends excessive time inside the litter box.

### SUMMARY OF THE INVENTION

The present invention solves the above mentioned problems by providing a litter box with a sidewall entrance and an open roof formed by inwardly arced gutters. The sidewall entrance also includes an inwardly arced gutter that extends from the bottom edge of the sidewall entrance into the interior space of the litter box. The inwardly arced gutters redirect litter kicked against the walls of the litter box back into the center of the box to prevent litter spilling and tracking. The sidewall entrance allows animal easy access to the litter box. The open roof allows for better ventilation and animal comfort and prevents the litter box from being used as a safety hideout by animals. More specifically, the present invention provides the following litter box.

A first aspect of the present invention provides a litter box that includes a bottom, sidewalls extending upwards from the bottom (e.g., from the perimeter edges of the bottom), and an open roof topping the sidewalls. The bottom, the sidewalls and the roof define an interior space for animals to evacuate. In various embodiments, the bottom of the litter box may be configured to be lined with litter box filler or litter for absorbing moisture and odors such as ammonia from the animal feces and urine. Alternatively, the bottom of the litter box may be configured to be lined with a removable litter tray which can be lined with litter.

In a second aspect of the present invention, the litter box includes an open roof formed by inwardly arced roof gutter. The edges of the roof gutter define a top opening of the litter box that promotes air ventilation for animal comfort and prevents the litter box from being used as an animal safety hideout. In various embodiments, the roof gutter defines an inward arc such as an inward arc of approximately 180 degrees. In various embodiments, the roof gutter defines an inward arc having a radius of 1.5 to 2 inches. The roof gutter has a horizontal extension that extends horizontal towards the central vertical axis of the litter box. In various embodiments, the roof gutter extends horizontally from the sidewalls towards the center (e.g., the central vertical axis) of the litter box for at least around 4 inches. The adequate horizontal extension of the roof gutter into center of the litter box is needed to prevent litters from spilling outside when animals kicks the litter. In various embodiments, the roof gutter may form a continuous loop. In various other embodiments, the roof gutter may include discrete sections separated by open spaces.

In a third aspect of the present invention, the litter box includes a sidewall entrance that allows easy animal ingress and egress. In various embodiments, the sidewall entrance is placed on the front sidewall of the litter box. The sidewall entrance may also include an inwardly arced sidewall entrance gutter connected to the sidewall around the bottom edge of the sidewall entrances or connected to the bottom edge of the sidewall entrance. In various embodiments, the sidewall entrance gutter defines an inward arc such as an arc of approximately 180 degrees. In various embodiments, the sidewall entrance gutter defines an inward arc having a radius of 1.5 to 2 inches. The sidewall entrance gutter has a horizontal extension that extends from the sidewall (e.g., from the bottom edge of the sidewall entrance) of the litter box into the interior space (e.g., towards the central vertical axis) of the litter box, in various embodiments by at least approximately 4 inches horizontally. The sidewall entrance gutter prevents litter from spilling and redirects litter back into the litter box when animals kick the litter.

In one embodiment of the present invention, the litter box is approximately cuboid in shape with a dimension of roughly 36 inches in length, 24 inches in width, and 20 inches in height. The litter box includes a roughly rectangular bottom. Sidewalls extend vertically upwards from the outer edges of the bottom. The roof gutter includes four sections forming a loop above the top edges of the sidewalls, with one section above the top edge of the front sidewall, one section above the top edge of the back sidewall, and two sections above the top edges of the lateral sidewalls. The inner edges of the four sections of the roof gutter define a top opening for better ventilation and for preventing the litter box from being used as a safety hideout. The four sections of the roof gutter are separated from their respectively adjacent sections with 1-2 inches open spaces. The roof gutter defines an arc of approximately 180 degrees and a radius of 1.5 to 2 inches. Each of the roof gutters has a horizontal extension extending approximately 4 inches horizontally towards the central vertical axis of the litter box from the corresponding sidewall (e.g., from around the top edges of the corresponding sidewall). In this embodiment, the roof gutter is part of a removable lid that can be removably secured to the top edges of the sidewalls of the litter box. The lid further includes handles for carrying the litter box. When the lid is removed, the litters, litter tray and/or linings placed inside the litter box can be easily removed, replaced and/or cleaned. When the lid is attached to the litter box, in this case attached to the sidewalls of the litter box, the litter box can be carried using the handles provided on the lid.

### BRIEF DESCRIPTION OF THE DRAWINGS

Various embodiments of the invention are disclosed in the following detailed description and the accompanying drawings.

FIG. 1 is a perspective view of an animal litter box according to an embodiment of the present invention, viewed from a front side.

FIG. 2 is a perspective view of the animal litter box embodiment of FIG. 1, viewed from a front side and showing the cross-sectional plane A-A.

FIG. 3 is a top view of the animal litter box embodiment of FIG. 1, without showing the litter at the bottom of the animal litter box.

FIG. 4 is a top view of the animal litter box embodiment of FIG. 1, showing the the litter placed at the bottom of the animal litter box.

FIG. 5 is perspective view of the animal litter box embodiment of FIG. 1, viewed from a lateral side.

FIG. 6 is a perspective view of the animal litter box of FIG. 1, viewed from a lateral side and showing the cross-sectional plane B-B

FIG. 7 is a cross-sectional view of the animal litter box embodiment of FIG. 1 along the cross-sectional plane A-A as shown in FIG. 2.

FIG. 8 is a cross-sectional view of the animal litter box embodiment of FIG. 1 along the cross-sectional plane B-B as shown in FIG. 6.

### DETAILED DESCRIPTION

In the following, embodiments of animal litter box according to the present invention are described in details in reference to the accompanying drawings. In should be appreciated the examples shown are intended to merely illustrate the invention and should not be construed as limiting to the scope of the invention. The drawings are not necessarily in scale and/or in proportion, emphasis is instead being placed on the principles of the disclosure.

Unless defined otherwise herein, all technical and scientific terms have the same meaning as commonly understood by one of ordinary skilled in the art to which this invention belongs. As used herein and in the appended claims, the singular forms “a”, “an”, and “the” include plural references unless the context clearly dictates otherwise.

The animal litter box of the present invention can be used by any domesticated animal such as cat, dog, rabbit, pig, or a combination thereof. It can be made from any suitable material that an animal litter box is normally made of, such as any suitable plastic, composite, wood, ceramic and metal material.

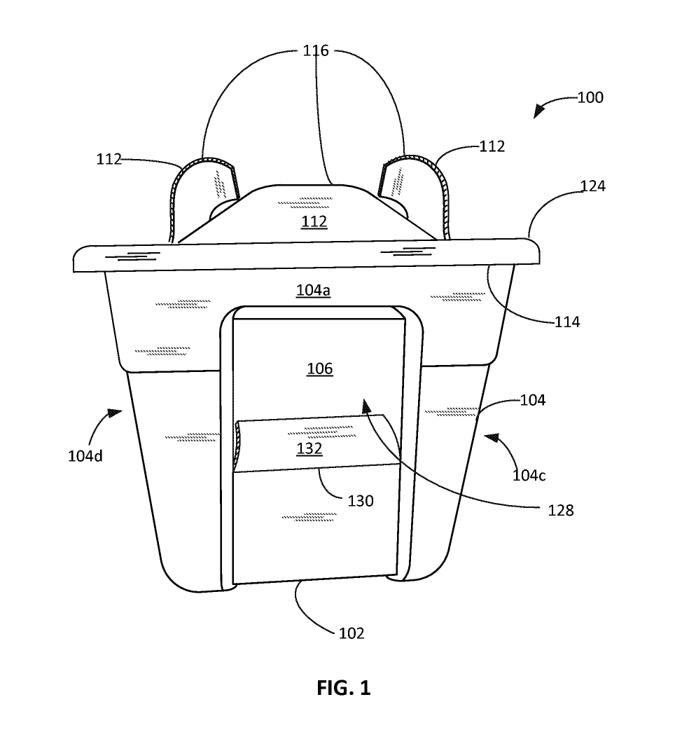

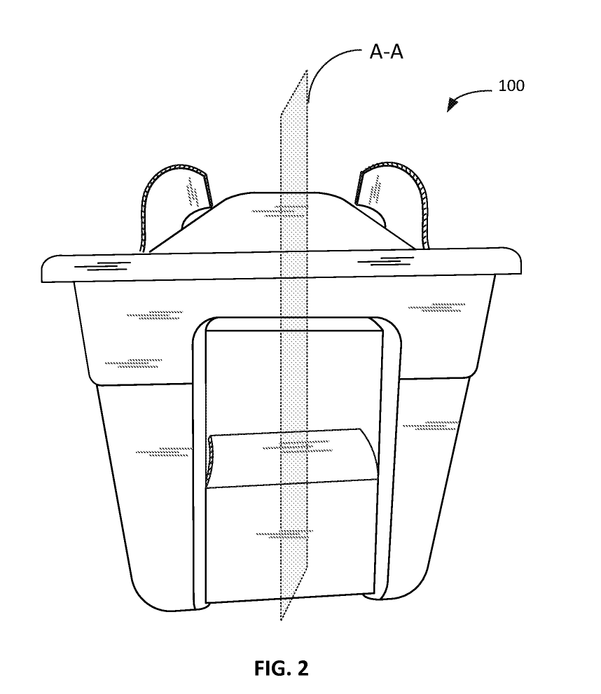

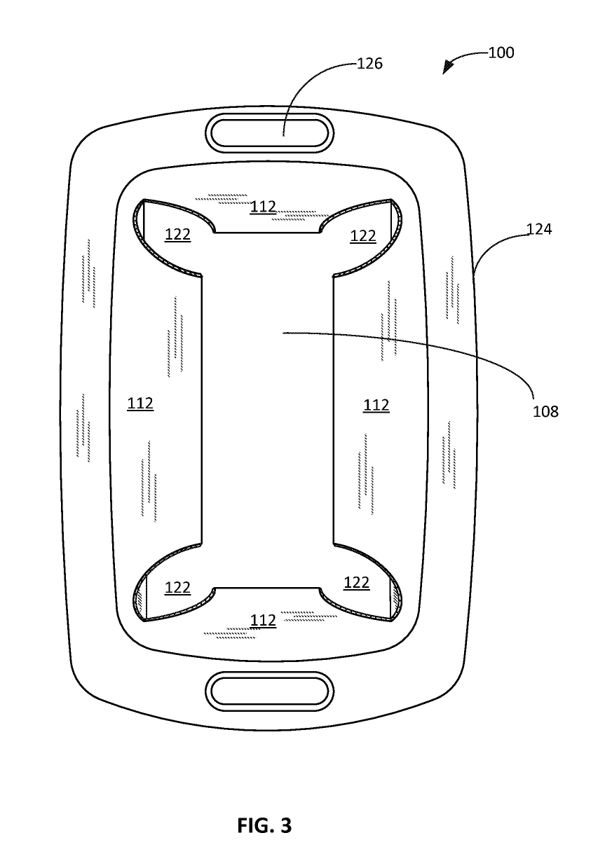

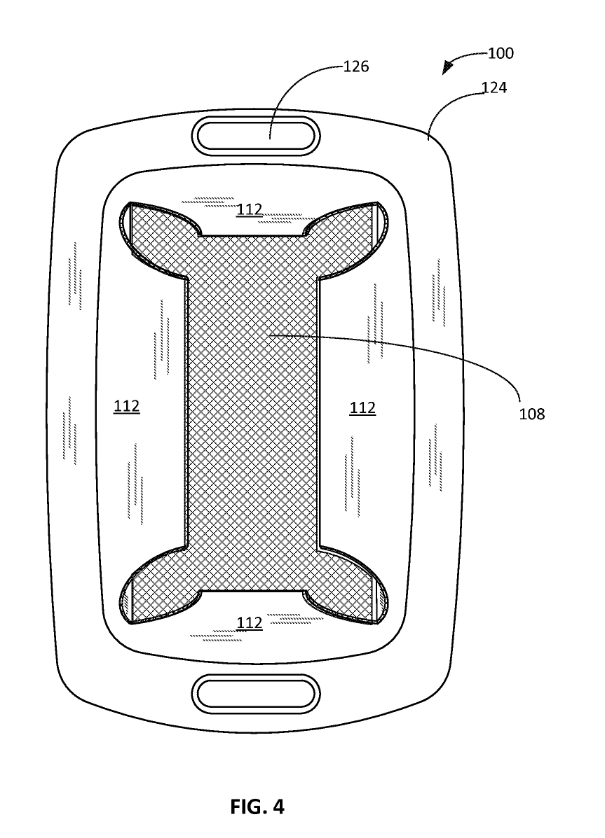

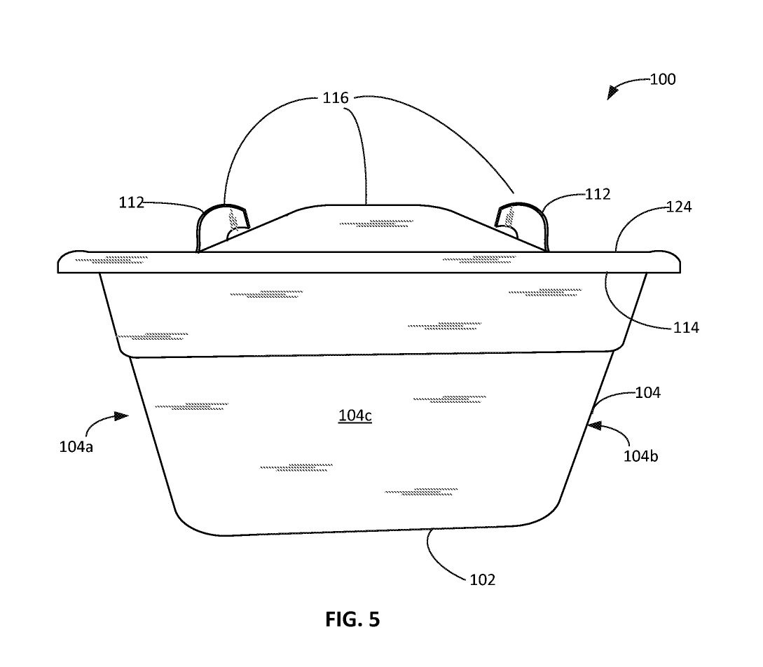

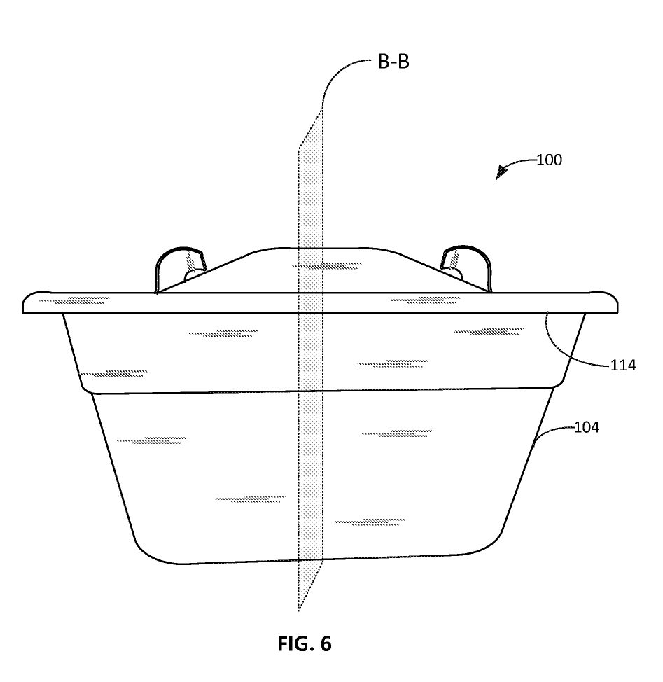

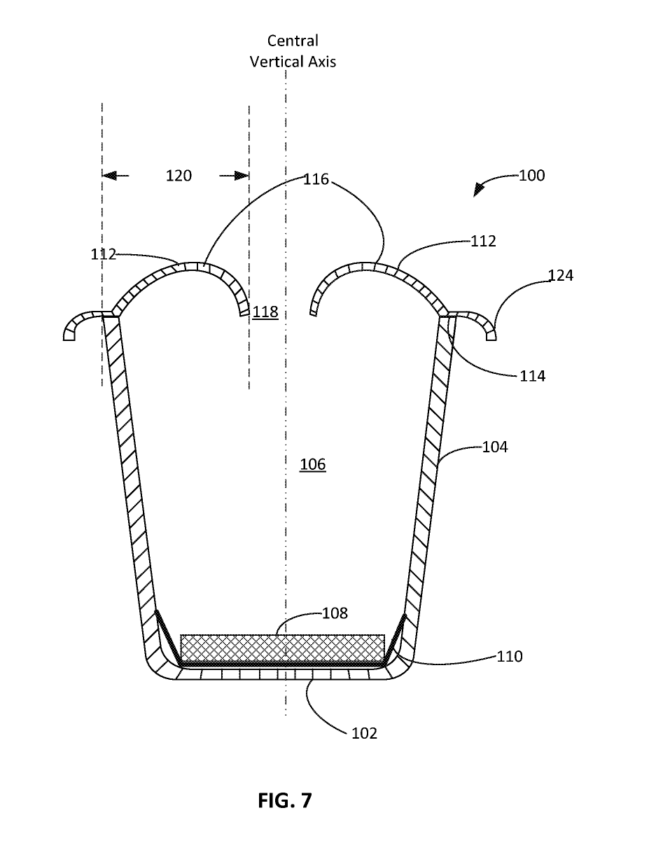

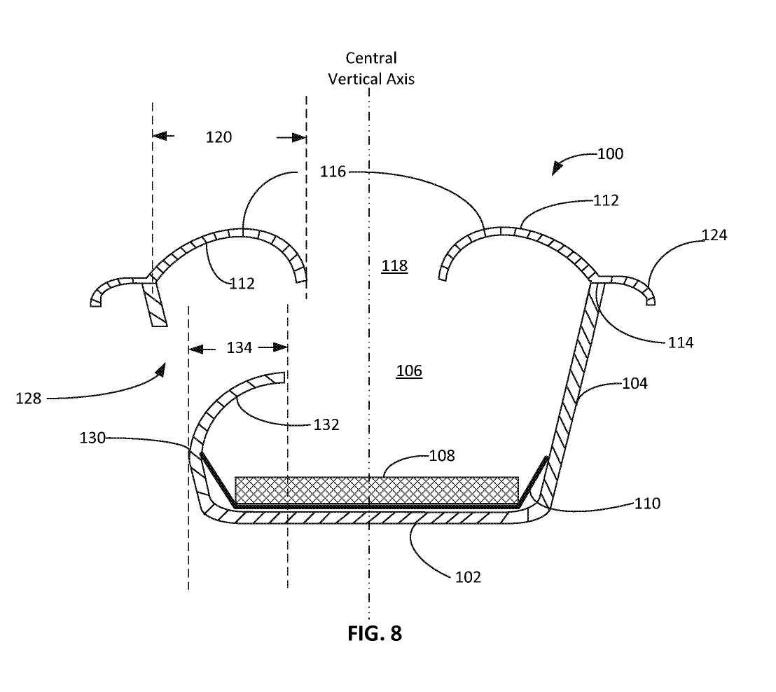

FIGS. 1 to 8 illustrate one embodiment of animal litter box 100 in accordance with the present invention. FIGS. 1 and 2 are a perspective view, viewed from a front side. FIGS. 3 and 4 are top views. FIGS. 5 and 6 are perspective view, viewed from a lateral side. FIG. 7 is a cross-sectional view of a cross section along the cross-sectional plane A-A. FIG. 8 is a cross-sectional view of a cross section along the cross-sectional plane B-B. References are made to FIGS. 1 to 8 in describing the embodiment 100 of the present invention below. It should be noted that although the invention is described in reference to the embodiment 100, it is not limited by the embodiment 100.

The animal litter box 100 includes a bottom 102 and sidewall 104 extending upwards from the bottom 102 to define an interior space 106. In various embodiments, the sidewall 104 extends vertically upwards from the edges of the bottom 102. The interior space 106 is configured to be used by animals to evacuate. The bottom 102 is not limited to the rectangular shape shown here, it can be any other suitable shape such as but not limited to oval, circular, or other more complex shapes and patterns. The sidewall 104 is also not limited to the shape shown here, it may be straight or curved. The overall shape of the animal litter box 100 can also be any suitable shape, not limited to the cuboidal shape shown here.

The bottom 102 is configured to be filled with approximately an inch or more of litter box filler or litter 108 which is typically granular material designed to absorb moisture and odor such as ammonia from animal feces and urine. Some example litter box filler 108 are clay, recycled paper pellets and silica-based crystals. In some embodiments, the bottom 102 may be lined with a removable litter tray 110 which in turn can be filled with litter box filler 108, the litter tray 110 can be taken out and cleaned.

Inwardly arced roof gutter 112 tops the upper edges 114 of the sidewalls 104 to form an open roof 116 with a top opening 118. The top opening 118 formed by the open roof 116 promotes air ventilation for animal comfort and prevents the litter box from being used as an animal safety hideout.

In various embodiments, the roof gutter 112 defines an inward arc such as an inward arc of approximately 180 degrees having a radius of 1.5 to 2 inches. The roof gutter 112 has a horizontal extension 120 that extends horizontally toward the central vertical axis of the litter box, in the example shown, by about 4 inches from the edges of the sidewalls. Adequate horizontal extension (typically at least approximately 4 inches) is needed to prevent litters from spilling outside and to redirect litters back into the litter box 100 when animals kicks the litter. Although in various embodiments, the roof gutter 112 may form one continuous loop, in the example shown the roof gutter 112 includes four discrete sections separate by open spaces 122 between adjacent roof gutter sections. These open spaces 122 can serve to further enhance ventilation.

In the example shown, the roof gutter 112 is part of a removable lid 124 of the litter box 100, although in other embodiments, the roof gutter may be permanently attached to and extends from the upper edges 114 of the sidewalls 104. The lid 124 can be removed to allow easy access to the interior space 106. For example, the lid can be removed to allow litter box filler 108, litter tray 110 to be removed, replaced, and/or cleaned. The lid 124 may include mechanisms to secure the lid to the rest of the litter box, the mechanism may be any suitable securing mechanisms known in the art, such as latches, clips, clamps, crimps, and snap-ons. In various other embodiments, the roof gutter 112 is permanently attached to the sidewalls of the litter box. For example, the roof gutter may be attached to the upper edges 114 of the sidewalls 104 and extends the central vertical axis of the litter box from the upper edges 114 of the sidewalls 104. In various embodiments, the litter box may also include mechanisms that allow the animal litter box 100 to be carried. Such mechanisms can for example be handles 126 shown in this example.

A sidewall entrance 128 is positioned on the sidewall 104. The sidewall entrance 128 needs to be large enough for easy animal ingress and egress. In the example shown, the sidewall 104 includes a front sidewall 104a, a back sidewall 104b (opposite of the front sidewall and cannot be seen from a front perspective view), two lateral sidewalls 104c, 104d, the sidewall entrance 128 is placed on the front sidewall 104a at about 4 inches above the bottom 102. The size of the sidewall entrance 128 may vary depending on the type and size of animal the animal litter box is intended for. For example, a litter box for small animals such as small cats would have smaller sidewall entrance as compared to that for larger animals such as large dogs. The bottom edge 130 of the sidewall entrance 128 needs to be positioned at an adequate distance above the bottom 102 to allow enough space to keep litter 108 inside the litter box 100 when animal kicks the litter. Typically a distance of at least 4 inches is needed.

The sidewall entrance 128 may also include an inwardly arced sidewall entrance gutter 132 placed at the bottom edge 130 of the sidewall entrance 128. In various embodiments, the sidewall entrance gutter 132 defines an inward arc such as an arc of approximately 180 degrees and approximately 1.5 to 2 inches. The sidewall entrance gutter has a horizontal extension 134 that extends into the interior space 106 with a horizontal extension that is typically at least 4 inches. Adequate horizontal extension of the sidewall entrance gutter is needed to prevent litters from spilling outside and to redirect litters back into the litter box 100 when animals kick the litter to prevent litter tracking.

The dimension of the animal litter box 100 may vary depending on the type and size of the animal the litter box 100 is intended for. For example, a litter box for smaller animals such as small cats tend to be smaller in dimension the litter box for larger animals such as large dogs. In the example shown, the litter box 100 has the dimension of 36 inches long, 24 inches wide and 20 inches high, and it is especially suitable for small animals such as cats.

What is claimed:

1. An animal litter box, comprising:
a bottom;
sidewall extending upwardly from the bottom;
an inwardly arced roof gutter tops the sidewalls to form an open roof;
wherein the bottom, sidewall and inwardly arced roof gutter defines an interior space for animal evacuation;
sidewall entrance disposed on the sidewall configured to allow animals to come in and out of the interior space;
inwardly arced sidewall entrance gutter disposed near a bottom edge of the sidewall entrance and extending into the interior space.

2. The animal litter box of claim 1, wherein the bottom edge of the sidewall entrance is 3-4 inches above the bottom.

3. The animal litter box of claim 1, wherein the sidewall entrance gutter includes a horizontal extension extending into the interior space of the animal litter box.

4. The animal litter box of claim 3, wherein the sidewall entrance gutter includes a horizontal extension extending approximately 4 inches into the interior space of the animal litter box.

5. The animal litter box of claim 1, wherein the sidewall entrance gutter defines an arc of approximately 180 degrees.

6. The animal litter box of claim 1, wherein the sidewall entrance gutter defines an arc having a radius of approximately 1.5 to 2 inches.

7. The animal litter box of claim 1, wherein the bottom is roughly in the shape of a rectangle having four edges, the sidewall comprises a front sidewall, two lateral sidewalls and a back sidewall, the sidewalls extends vertically upward from the four edges of the bottom, and wherein the sidewall entrance is disposed on the front sidewall.

8. The animal litter box of claim 1, wherein the roof gutter comprises four discrete sections that form a loop around the sidewall, and wherein adjacent sections are separated by empty spaces.

9. The animal litter box of claim 1, wherein the roof gutter defines an arc of approximately 180 degrees.

10. The animal litter box of claim 1, wherein the roof gutter defines an arc having a radius of 1.5 to 2 inches.

11. The animal litter box of claim 1, wherein the animal litter box has a dimension of approximately 36 inches in length, 24 inches in width and 20 inches in height.

12. The animal litter box of claim 1, wherein the roof gutter forms a part of a removable lid of the animal litter box.

13. The animal litter box of claim 1, wherein the roof gutter is permanently attached to top edges of the sidewall.

14. A animal litter box, comprising
a bottom;
sidewalls extending upwardly from perimeter edges of the bottom;
an inwardly arced roof gutter tops the sidewalls to form an open roof;
wherein the bottom, sidewalls and inwardly arced roof gutter define an interior space for animal evacuation;
sidewall entrance disposed on the sidewall configured to allow animals to come in and out of the interior space; and
inwardly arced sidewall entrance gutter disposed near a bottom edge of the sidewall entrance and extending into the interior space;
wherein:
the bottom edge of the sidewall entrance is 3-4 inches above the bottom;
the sidewall entrance gutter includes a horizontal extension extending approximately 4 inches into the interior space of the animal litter box;
the sidewall entrance gutter defines an arc of approximately 180 degrees and a radius of approximately 1.5 to 2 inches;
the roof gutter comprises four discrete sections that form a loop around top edges of the sidewall, and wherein adjacent sections are separated by empty spaces;
the roof gutter defines an arc of approximately 180 degrees and a radius of 1.5 to 2 inches the bottom is roughly in the shape of a rectangle;
the sidewall comprises a front sidewall, two lateral sidewalls and a back sidewall;
the sidewall entrance is disposed on the front sidewall; and
the animal litter box has a dimension of approximately 36 inches in length, 24 inches in width and 20 inches in height.
